(19) United States
(12) Patent Application Publication
(10) Pub. No.: US 2021/0132764 A1
(43) Pub. Date: May 6, 2021

(54) DISPLAY DEVICE WITH BUILT-IN TOUCH SENSOR, AND DRIVE METHOD FOR SAME

(71) Applicant: SHARP KABUSHIKI KAISHA, Sakai City, Osaka (JP)

(72) Inventors: MASASHI MAYUMI, Sakai City, Osaka (JP); SHINICHI MIYAZAKI, Sakai City, Osaka (JP)

(21) Appl. No.: 16/627,103

(22) PCT Filed: Jul. 6, 2018
(86) PCT No.: PCT/JP2018/025670

§ 371 Date: Dec. 27, 2019

(30) Foreign Application Priority Data
Jul. 14, 2017 (JP) 2017-137635

(51) Int. Cl. G06F 3/041

(52) U.S. Cl. CPC G06F 3/04164; G06F 3/04162; G06F 2203/04114; G06F 2203/04104; G06F 3/0412

(57) ABSTRACT

To realize a display device with a built-in touch sensor, the display device having a small-scale circuit and being capable of performing accurate touch detection even when an operation means except for a finger (e.g., stylus pen) is in use. When a detection target is an operation means except for a finger (e.g., stylus pen), touch detection is performed in a first scanning period in a state where each a plurality of sensor electrodes arranged side by side in a first direction (e.g., a direction in which scanning signal lines extend) are connected electrically, and touch detection is performed in a second scanning period in a state where each a plurality of sensor electrodes arranged side by side in a second direction (e.g., a direction in which video signal lines extend) are connected electrically.

### TECHNICAL FIELD

The following disclosure relates to a display device with a built-in touch sensor and a drive method for the same, and more specifically relates to a display device with a built-in touch sensor, in which a common electrode being used for image display is also used as a sensor electrode (electrode for touch detection), and a drive method for the same.

### BACKGROUND ART

A touch panel has been attracting attention as an input device for performing an operation in a computer system or the like. For example, in a capacitive-type touch panel, the position of an object to be detected, such as a finger of a user (operator) or a touch pen, is detected based on a change in electrostatic capacitance. Such a touch panel has hitherto been used as superimposed on a display panel such as a liquid crystal panel. Such a touch panel provided on the display panel is called an “out-cell type touch panel.” The out-cell type touch panel has, for example, a sensor pattern as shown in FIG. 32 made up of two types of rhomboid electrodes (horizontally connected electrodes 901 and vertically connected electrodes 902).

However, the out-cell type touch panel has had problems of an increase in weight and thickness of the entire device including the display panel and the touch panel and an increase in power required for driving the touch panel. Therefore, in recent years, the development of a display device with a configuration in which a display panel and a touch panel are integrated has progressed. In such a display device, a portion that functions as a touch sensor is included in the display panel. Accordingly, hereinafter, such a display device is referred to as a “display device with a built-in touch sensor.”

By the way, the touch panel integrated with the display panel mainly includes a so-called “on-cell type touch panel” and an “in-cell type touch panel.” As for the on-cell type touch panel, a sensor electrode is provided between one of two glass substrates constituting the display panel and the polarizing plate. As for the in-cell type touch panel, a sensor electrode is provided inside two glass substrates.

While there are several types of touch panels as described above, the in-cell type touch panel is becoming a mainstream in the market in recent years. The in-cell type touch panel is expected to be used in various applications. For example, the in-cell type touch panel is particularly expected to be used in mobile phones (particularly smartphones), tablet terminals, personal computers, amusement devices, in-vehicle devices, industrial equipment, and the like.

The in-cell type touch panel has, for example, a sensor pattern as shown in FIG. 33 including a plurality of sensor electrodes 91 arranged in a matrix on a glass substrate. Touch detecting wires 92 are also provided on the glass substrate. Each sensor electrode 91 is connected to a corresponding touch detecting wire 92 at a contact portion 93. The touch detecting wires 92 are connected to an IC including a circuit or the like that performs processing for specifying a touched position based on a detection signal obtained from each sensor electrode 91. In the configuration as described above, the plurality of sensor electrodes 91 arranged on the glass substrate are shared with an electrode (e.g., a common electrode in a liquid crystal display device) used for displaying an image. That is, one electrode is used as a sensor electrode for performing touch detection and is also used as an electrode for image display. By sharing the electrode for image display with the sensor electrode in this manner, it is possible to achieve reduction in thickness and weight of the device.

It should be noted that, in connection with this matter, Japanese Laid-Open Patent Publication No. 2015-164033 discloses an invention of a display device with a sensor which is provided with a pair of touch sensor electrodes in which a plurality of electrodes extending in one direction are arranged so as to intersect each other.

### PRIOR ART DOCUMENT

### Patent Document

[Patent Document 1] Japanese Laid-Open Patent Publication No. 2015-164033

### SUMMARY OF THE INVENTION

### Problems to be Solved by the Invention

By the way, in recent years, a stylus pen called “Active Stylus” or the like is increasingly used as an operation means for a touch panel. For example, some of products called “2 in 1” usable as notebook computers and also usable as tablet devices are equipped with “Active Stylus” as standard. Employing such a stylus pen enables, for example, highly accurate input. However, in a case in which an in-cell type touch panel is employed, it may be difficult to employ the stylus pen. The reason for this will be described below.

In the display device that employs the in-cell type touch panel, since the electrode for image display and the sensor electrode (electrode for touch detection) are shared as described above, processing for image display and processing for touch detection cannot be performed at the same time. Accordingly, the processing for image display and the processing for touch detection are performed in a time-division manner. That is, a display period during which the processing for image display is performed and a touch detection period during which the processing for touch detection is performed are repeated alternately. In this regard, when low-resolution display is performed, the display period can be set to a relatively short period, so that a relatively long period can be ensured as the touch detection period (see FIG. 34). In contrast, when a high-resolution display is performed, a relatively long period needs to be ensured as the display period, thus making the touch detection period relatively short (see FIG. 34). Here, with respect to the display device, the progress of higher resolution is remarkable. For this reason, the length of the touch detection period may become insufficient, and the accuracy in touch detection may decrease.

Further, in the display device that employs the in-cell type touch panel, the components of the touch panel are provided inside the display panel. This causes an increase in panel load. In this regard, FIG. 35 shows the relationship between time and a charging rate of touch detecting capacitance. In FIG. 35, a change in charging rate in the case of a low-load is indicated by a solid line, and a change in charging rate in the case of a high-load is indicated by a thick dotted line. As can be understood from FIG. 35, the charging rate changes more gradually with increase in panel load. Accordingly, when the panel load increases, the charge of the touch detecting capacitance may become insufficient, and the accuracy in touch detection may decrease.

In addition, it is difficult to employ the stylus pen from the viewpoint of cost and size. Generally, as compared to a finger, an active stylus pen is required to have high detection accuracy, high-speed response, and high-speed sensing for smoothing processing. Thus, an analog front end (AFE) for processing a detection signal is important in order to enable detection of touch with the stylus pen. The AFE is typically provided in an IC in a display device that employs an in-cell type touch panel. The AFE includes, for example, an integration circuit made up of an operational amplifier and a capacitor, an AD converter, and the like. When a large number of AFEs as above are provided, the computing power per unit time is improved. However, the circuit scale increases, and hence the cost increases while the size of the IC increases.

As described above, in a case in which the in-cell type touch panel is employed, it may be difficult to employ the stylus pen. In this regard, particularly in recent years, the narrowing of the picture frame has been advanced so as to widen the display region of the apparatus. As a result, the allowable range as a mounting area for driving components has become smaller than in the conventional case, and there is a demand for reduction in circuit scale. There is also a strong demand for cost reduction. However, under the circumstances described above, it is difficult to accurately detect touch with the stylus pen while satisfying the demands for reduction in circuit scale and cost. Furthermore, the same can be considered when new operation means except for the stylus pen are developed in the future.

Therefore, an object of the following disclosure is to realize a display device with a built-in touch sensor that has a small-scale circuit and is capable of performing accurate touch detection even when an operation means except for a finger (e.g., stylus pen) is in use.

### Means for Solving the Problem

A display device according to one embodiment is a display device with a built-in touch sensor, the display device having a display unit provided with K (K is an integer of 4 or more) sensor electrodes for touch detection arranged in a matrix, the display device including:

a plurality of analog front ends for processing detection signals obtained from the K sensor electrodes;

a grouping unit configured to perform

first grouping processing for electrically connecting each P (P is an integer of 2 or more and K/2 or less) sensor electrodes arranged side by side in a first direction so that each group is made up of the P sensor electrodes, and

second grouping processing for electrically connecting each Q (Q is an integer of 2 or more and K/2 or less) sensor electrodes arranged side by side in a second direction orthogonal to the first direction so that each group is made up of the Q sensor electrodes; and

a position detection processing unit configured to determine whether the K sensor electrodes are touched and specify a touched position, based on outputs from the plurality of analog front ends, wherein

in the first grouping processing and the second grouping processing, the grouping unit connects sensor electrodes constituting each group to an analog front end that is different from analog front ends to which sensor electrodes constituting another group are connected.

Further, a drive method for a display device according to one embodiment is a drive method for a display device with a built-in touch sensor, the display device having a display unit provided with K (K is an integer of 4 or more) sensor electrodes for touch detection arranged in a matrix, and a plurality of analog front ends for processing detection signals obtained from the K sensor electrodes, the method including:

a first grouping step of electrically connecting each P (P is an integer of 2 or more and K/2 or less) sensor electrodes arranged side by side in a first direction so that each group is made up of the P sensor electrodes;

a second grouping step of electrically connecting each Q (Q is an integer of 2 or more and K/2 or less) sensor electrodes arranged side by side in a second direction orthogonal to the first direction so that each group is made up of the Q sensor electrodes; and

a position detection step of determining whether the K sensor electrodes are touched and specifying a touched position, based on outputs from the plurality of analog front ends, wherein

in the first grouping step and the second grouping step, sensor electrodes constituting each group are connected to an analog front end that is different from analog front ends to which sensor electrodes constituting another group are connected.

### Effects of the Invention

According to the configuration as described above, when an operation means except for the finger (e.g., stylus pen) is in use, it is possible to perform touch detection in a state where each a plurality of sensor electrodes arranged side by side in a first direction (e.g., a direction in which scanning signal lines extend) are connected electrically and touch detection in a state where each a plurality of sensor electrodes arranged side by side in a second direction (e.g., a direction in which video signal lines extend) are connected electrically. Since the touch detection can be performed in a state where a plurality of sensor electrodes are grouped in this manner, detection signals can be sufficiently processed by a relatively small number of analog front ends. In addition, when a pen or the like is in use on a tablet terminal, a product called “2 in 1”, a notebook computer, a mobile phone (especially a smartphone), and the like, it is sufficient to be able to specify one touched position, and hence the touched position can be accurately specified by two touch detections in the above-described state. As above, a display device with a built-in touch sensor that has a small-scale circuit and is capable of performing accurate touch detection even when an operation means except for a finger (e.g., stylus pen) is in use is realized.

### BRIEF DESCRIPTION OF THE DRAWINGS

FIG. 1 is a diagram for explaining specification of a touched position when a detection target is a stylus pen in one embodiment of the present invention.

FIG. 2 is a block diagram for explaining a functional configuration of a liquid crystal display device with a built-in touch sensor in the embodiment.

FIG. 3 is a diagram for explaining an example of a physical configuration in the embodiment.

FIG. 4 is a circuit diagram showing a configuration of a pixel formation portion in the embodiment.

FIG. 5 is a diagram for explaining a sensor pattern constituting a touch panel in the embodiment.

FIG. 6 is a diagram showing a schematic configuration of an IC in the embodiment.

FIG. 7 is a diagram for explaining switching of connection destinations of AFEs in the conventional case.

FIG. 8 is a diagram showing a state of sensor electrodes when a detection target is a finger in the embodiment.

FIG. 9 is a diagram showing a state of the sensor electrodes in a first scan period when the detection target is a stylus pen in the embodiment.

FIG. 10 is a diagram showing a state of the sensor electrodes in a second scan period when the detection target is a stylus pen in the embodiment.

FIG. 11 is a diagram showing a connection state in the first scan period in the embodiment.

FIG. 12 is a diagram showing a connection state in the second scan period in the embodiment.

FIG. 13 is a diagram for explaining a grouping unit in the embodiment.

FIG. 14 is a diagram showing a first example of a specific configuration of a switch group in the embodiment.

FIG. 15 is a diagram showing the connection relationship in the first scan period in a case in which the first example is employed to the configuration of the switch group in the embodiment.

FIG. 16 is a diagram showing the connection relationship in the second scan period in a case in which the first example is employed to the configuration of the switch group in the embodiment.

FIG. 17 is a diagram showing the connection relationship when the detection target is a finger in a case in which the first example is employed to the configuration of the switch group in the embodiment.

FIG. 18 is a diagram showing a second example of a specific configuration of a switch group in the embodiment.

FIG. 19 is a diagram showing the connection relationship in the first scan period in a case in which the second example is employed to the configuration of the switch group in the embodiment.

FIG. 20 is a diagram showing the connection relationship in the second scan period in a case in which the second example is employed to the configuration of the switch group in the embodiment.

FIG. 21 is a diagram showing the connection relationship when the detection target is a finger in a case in which the second example is employed to the configuration of the switch group in the embodiment.

FIG. 22 is a diagram for explaining a time-division drive method in the embodiment.

FIG. 23 is a diagram for explaining the time-division drive method in the embodiment.

FIG. 24 is a diagram for explaining a touched position in the embodiment.

FIG. 25 is a diagram for explaining a touched position in the embodiment.

FIG. 26 is a diagram for explaining a touched position in the embodiment.

FIG. 27 is a diagram for explaining a touched position in the embodiment.

FIG. 28 is a table showing a change in charging rate with time by case for certain simulation.

FIG. 29 is a diagram for explaining “Case 1” in FIG. 28.

FIG. 30 is a diagram for explaining “Case 2” in FIG. 28.

FIG. 31 is a diagram for explaining “Case 3” in FIG. 28.

FIG. 32 is a diagram showing an example of a sensor pattern of an out-cell type touch panel.

FIG. 33 is a diagram showing an example of a sensor pattern of an in-cell type touch panel.

FIG. 34 is a diagram for explaining that a display period and a touch detection period are alternately repeated in a display device that employs the in-cell type touch panel

FIG. 35 is a diagram showing the relationship between time and a charging rate of a touch detecting capacitance.

### MODE FOR CARRYING OUT THE INVENTION

Hereinafter, an embodiment of the present invention will be described with reference to the accompanying drawings

<1. Functional Configuration>

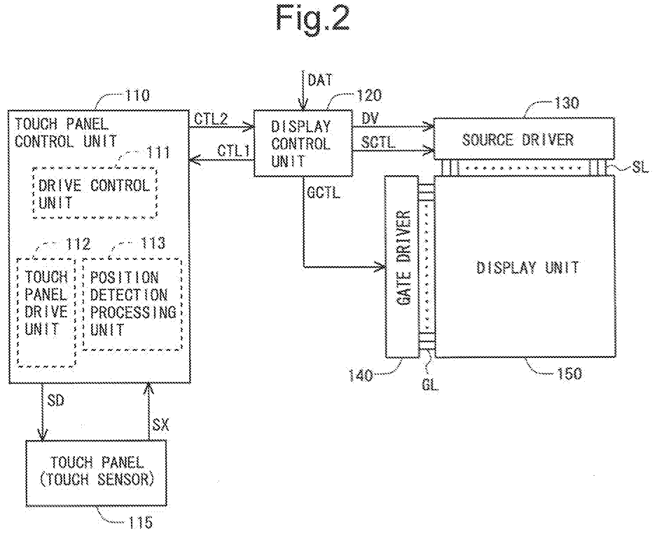

FIG. 2 is a block diagram for explaining a functional configuration of a liquid crystal display device with a built-in touch sensor according to an embodiment of the present invention. The liquid crystal display device includes a touch panel control unit 110, a touch panel (a touch sensor) 115, a display control unit 120, a source driver 130, a gate driver 140, and a display unit 150. The touch panel control unit 110 and the touch panel 115 are components related to touch detection, and the display control unit 120, the source driver 130, the gate driver 140, and the display unit 150 are components related to image display. It should be noted that, since FIG. 2 is the diagram showing the functional configuration, the positional relationship among the components is different from the actual one.

The touch panel control unit 110 includes a drive control unit 111, a touch panel drive unit 112, and a position detection processing unit 113. The touch panel control unit 110 controls the operation of the touch panel 115. At that time, the touch panel drive unit 112 gives a drive signal SD for performing the touch detection to the touch panel 115 based on a control signal CTL1 given from the display control unit 120. Note that the control signal CTL1 is a signal for performing processing for touch detection (a signal for controlling the timing) during a period when the processing for image display is not performed. When a detection signal SX as a detection result is given from the touch panel 115 to the touch panel control unit 110, the position detection processing unit 113 detects, based on the detection signal SX, a position where the touch panel 115 is touched. Then, the touch panel control unit 110 gives a control signal CTL2 to the display control unit 120 so that processing in accordance with the touched position is performed. It should be noted that, in the present embodiment, it is possible to detect touch with a finger and a stylus pen, and the drive control unit 111 controls switching of a drive system between drive with a finger as a detection target and drive with a stylus pen as the detection target.

The touch panel 115 detects a touch (more specifically, contact or approach of a recognition object) by a recognition object (the user's finger and the stylus pen in the present embodiment). The detection timing is determined based on the drive signal SD given from the touch panel control unit 110. The touch panel 115 gives the detection signal SX as the detection result to the touch panel control unit 110.

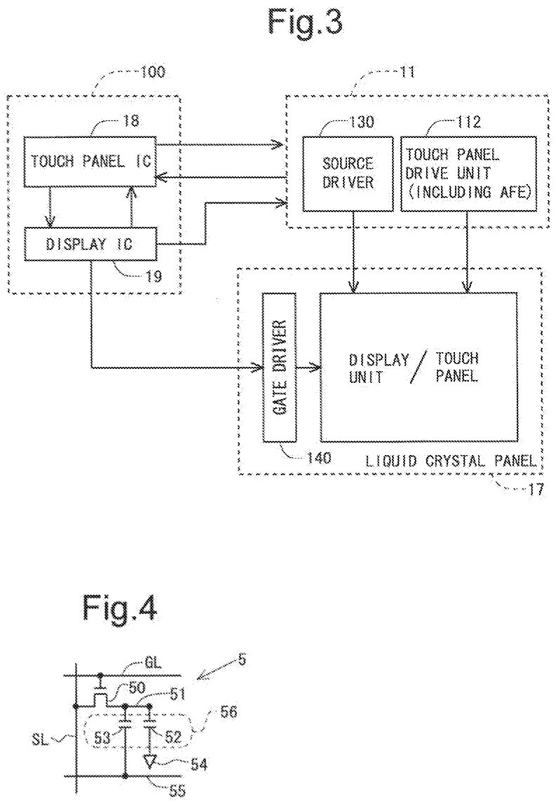

It should be noted that, physically, as ICs related to the components shown in FIG. 2, for example, an IC 11 having a function as the source driver 130 and a function as the touch panel drive unit 112, a touch panel IC 18, and a display IC 19 are provided as shown in FIG. 3. The liquid crystal panel 17 includes a portion that functions as the display unit and the touch panel and a portion that functions as the gate driver 140. The IC 11 is provided on a substrate (a TFT array substrate described later) constituting the liquid crystal panel 17. The touch panel IC 18 and the display IC 19 are provided on the back side of the substrate surface on which the IC 11 is provided via, for example, an FPC. It should be noted that, in the following, the touch panel IC 18 and the display IC 19 are collectively referred to as a “controller” for convenience of description. The controller is denoted by reference numeral 100.

The display unit 150 displays an image based on control by the source driver 130 and the gate driver 140. Meanwhile, the display unit 150 is provided with a plurality of source bus lines (video signal lines) SL and a plurality of gate bus lines (scanning signal lines) GL. A pixel formation portion for forming a pixel is provided corresponding to each of intersections between the plurality of source bus lines SL and the plurality of gate bus lines GL. That is, the display unit 150 includes a plurality of pixel formation portions. The plurality of pixel formation portions constitute a pixel matrix. FIG. 4 is a circuit diagram showing a configuration of a pixel formation portion 5. Each pixel formation portion 5 includes: a TFT (pixel TFT) 50 that is a switching element having a gate terminal connected to a gate bus line GL passing through a corresponding intersection, and a source terminal connected to a source bus line SL passing through the intersection; a pixel electrode 51 connected to a drain terminal of the TFT 50; a common electrode 54 and an auxiliary capacitance electrode 55 that are provided so as to be shared by the plurality of pixel formation portions 5; a liquid crystal capacitance 52 formed of the pixel electrode 51 and the common electrode 54; and an auxiliary capacitance 53 formed of the pixel electrode 51 and the auxiliary capacitance electrode 55. A pixel capacitance 56 is made up of the liquid crystal capacitance 52 and the auxiliary capacitance 53.

As the TFTs 50 in the display unit 150, it is possible to employ, for example, a thin-film transistor using an oxide semiconductor for a semiconductor layer (oxide semiconductor TFT). More specifically, a TFT having a channel layer formed of indium-gallium-zinc-oxide (In—Ga—Zn—O) which is an oxide semiconductor containing as the main components indium (In), gallium (Ga), zinc (Zn), and oxygen (O) (hereinafter referred to as “IGZO-TFT”) can be employed as the TFT 50. Since the oxide semiconductor has high electron mobility, the use of such an oxide semiconductor TFT as the IGZO-TFT enables the downsizing of the TFT 50 and is thus advantageous in terms of high definition and a high aperture ratio. Further, since a leakage current is reduced, it is advantageous in terms of reduction in power consumption. Furthermore, a voltage holding ratio of a pixel is increased. Note that various variations are applicable to the material of the semiconductor layer of the thin-film transistor. In addition to the thin-film transistor using the oxide semiconductor for the semiconductor layer, for example, a thin-film transistor using amorphous silicon for a semiconductor layer (a-Si TFT), a thin-film transistor using microcrystalline silicon for a semiconductor layer, a thin-film transistor using low-temperature polysilicon for a semiconductor layer (LTPS-TFT), and the like can be employed.

The display control unit 120 receives image data DAT transmitted from the outside and the control signal CTL2 transmitted from the touch panel control unit 110, and outputs a digital video signal DV, a source control signal SCTL for controlling the operation of the source driver 130, and a gate control signal GCTL for controlling the operation of the gate driver 140. The source control signal SCTL includes, for example, a source start pulse signal, a source clock signal, a latch strobe signal, and the like. The gate control signal GCTL includes a gate start pulse signal, a gate clock signal, and the like.

The source driver 130 applies a driving video signal to each source bus line SL based on the digital video signal DV and the source control signal SCTL which are transmitted from the display control unit 120. At this time, the source driver 130 sequentially holds the digital video signal DV representing a voltage to be applied to each source bus line SL at timing when a pulse of the source clock signal is generated. Then, the held digital video signal DV is converted into an analog voltage at timing when a pulse of the latch strobe signal is generated. The converted analog voltages are simultaneously applied to all the source bus lines SL as driving video signals.

Based on the gate control signal GCTL transmitted from the display control unit 120, the gate driver 140 repeats the application of the active scanning signal to each gate bus line GL with one vertical scanning period as a cycle.

As described above, the driving video signals are applied to the source bus lines SL, and the scanning signals are applied to the gate bus lines GL, whereby an image based on the image data DAT transmitted from the outside is displayed on the display unit 150. Further, when touch on the touch panel 115 is detected, processing in accordance with the touched position is performed in the liquid crystal display device.

<2. About Sensor Pattern>

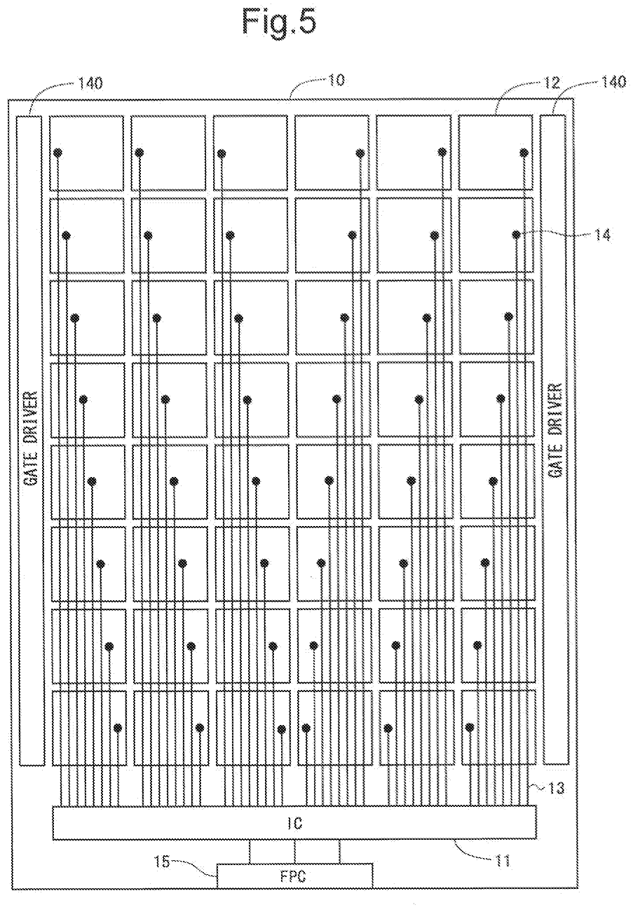

FIG. 5 is a diagram for explaining a sensor pattern constituting the touch panel 115 in the present embodiment. In the present embodiment, an in-cell type touch panel is employed. The liquid crystal display device according to the present embodiment has a liquid crystal panel made up of two glass substrates (a TFT array substrate and a color filter substrate) facing each other. Components for touch detection are provided on the TFT array substrate 10 of the two glass substrates. As shown in FIG. 5, on the TFT array substrate 10, as components for touch detection, sensor electrodes (electrodes for touch detection) 12, touch detecting wires 13, the above-described IC 11, and an FPC 15 are provided. The IC 11 is connected to the above-described controller 100 (the touch panel IC 18 and the display IC 19) via the FPC 15. In addition, on the TFT array substrate 10, contact portions 14 for connecting the sensor electrode 12 and the touch detecting wire 13 are provided. Note that, in a region on the TFT array substrate 10, the gate driver 140 described above is formed on both the left and right sides of a region where a plurality of sensor electrodes 12 are provided.

Meanwhile, in the present embodiment, one electrode functions as the common electrode 54 and also functions as the sensor electrode 12. Specifically, a plurality of (K, which is four or more) sensor electrodes 12 are formed by dividing a conventional common electrode in a matrix as shown in FIG. 5. In the example shown in FIG. 5, the conventional general common electrode has been divided into six pieces in the horizontal direction (the direction in which the gate bus line GL extends) and divided into eight pieces in the vertical direction (the direction in which the source bus line SL extends). Each divided electrode functions as the common electrode 54 when the processing for image display is performed, and functions as the sensor electrode 12 when the processing for touch detection is performed. Note that the number of divisions of the common electrode is not particularly limited so long as the common electrode is divided in accordance with a target resolution.

One end of the touch detecting wire 13 is connected to the contact portion 14 formed on the corresponding sensor electrode 12, and the other end of the touch detecting wire 13 is connected to the IC 11. Thereby, it is possible to give the drive signal SD from the IC 11 to each sensor electrode 12 and specify the touched position based on the detection signal SX.

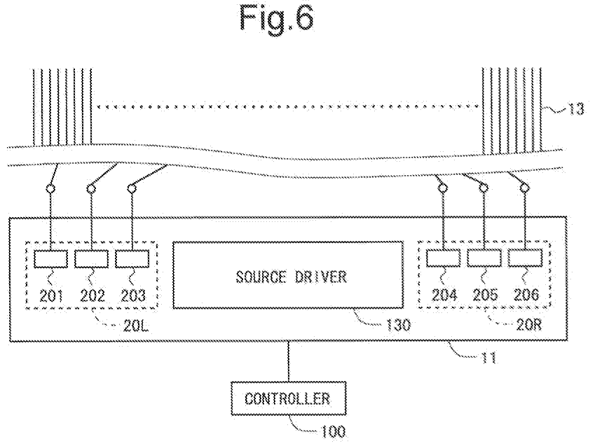

FIG. 6 is a diagram showing a schematic configuration of the IC 11. The IC 11 includes a source driver 130 and AFEs 201 to 206. The IC 11 Is connected to the controller 100, and the controller 100 includes a part of the touch panel control unit 110 and the display control unit 120 (see FIG. 2). As shown in FIG. 6, AFEs 201 to 203 are provided on one end side inside IC 11, and AFEs 204 to 206 are provided on the other end side inside IC 11. It should be noted that, in the following, a set of a plurality of AFEs is referred to as an “AFE block.” In the example shown in FIG. 6, an AFE block 20L is made up of three AFEs 201 to 203, and an AFE block 20R is made up of three AFEs 204 to 206.

It should be noted that, although the IC 11 includes components other than those shown in FIG. 6, they are not directly related to the present invention, and hence the description and illustration thereof are omitted.

Meanwhile, as described above, the touch panel control unit 110 includes the position detection processing unit 113 (see FIG. 2). That is, the position detection processing unit 113 is included in the controller 100 in the IC 11, and the position detection processing unit 113 determines whether or not the sensor electrodes 12 provided on the TFT array substrate 10 have been touched and specifies a touched position based on outputs from the plurality of AFEs 201 to 206.

Although two AFE blocks are provided in consideration of a case where the AFE characteristics are different between the one end side and the other end side inside the IC 11 in the present embodiment, the present invention is not limited to this, and only one AFE block may be provided.

<3. Drive Method>

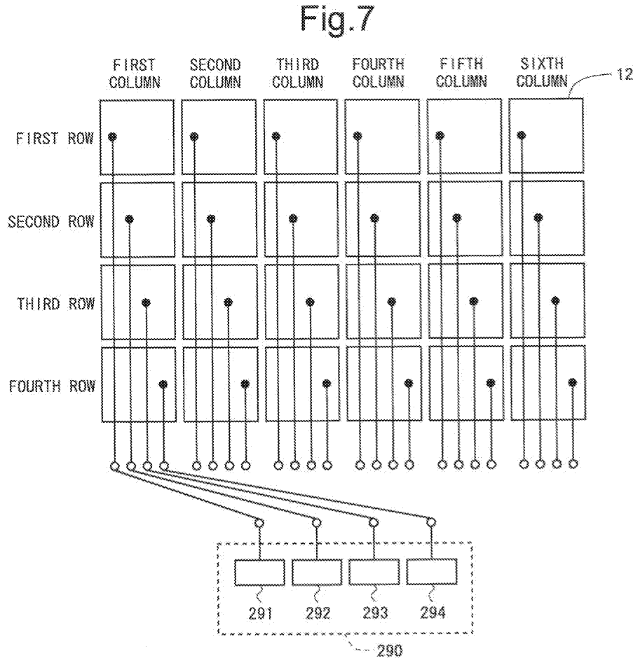

In the present embodiment, a self-capacitance scheme is employed as the position detection scheme. The self-capacitance scheme is a scheme in which a position of a recognition object is measured by detecting an increase in electrostatic capacitance caused by the contact or approach of the recognition object to the touch panel. By the way, conventionally, in a case in which a sensor pattern formed of a plurality of electrodes arranged in a matrix is employed, the processing for touch detection is performed while the connection destination of the AFE is switched using a switch. This will be described with reference to FIG. 7.

Here, for convenience of description, it is assumed that an AFE block 290 made up of four AFEs 291 to 294 is provided corresponding to 24 sensor electrodes 12 of four rows×six columns. In the configuration shown in FIG. 7, the processing for touch detection is sequentially performed one column by one column. That is, in a first predetermined period, the AFEs 291 to 294 are respectively connected to the sensor electrodes 12 in the first column (a state shown in FIG. 7) . In such a state, the drive signal SD is given to each sensor electrode 12, and it is determined whether or not each sensor electrode 12 in the first column has been touched based on the detection signal SX obtained accordingly. In the next predetermined period, the AFEs 291 to 294 are respectively connected to the sensor electrodes 12 in the second column. In such a state, the drive signal SD is given to each sensor electrode 12, and it is determined whether or not each sensor electrode 12 in the second column has been touched based on the detection signal SX obtained accordingly. Thereafter, in the same manner, it is determined whether or not each sensor electrode 12 in the third to sixth columns has been touched. Since determining whether there is a touch is performed for each sensor electrode 12 as thus described, even when a plurality of places are touched, a plurality of touched positions can be specified.

As described above, the processing for touch detection is performed while the connection destination of each of the AFEs 291 to 294 is switched. That is, each of the AFEs 291 to 294 is shared as a circuit for processing the detection signal SX obtained from the plurality of sensor electrodes 12. Sharing the AFE in this manner enables reduction in size of the IC 11 and reduction in cost. However, since the processing needs to be sequentially performed one column by one column as described above, the processing capacity per unit time is reduced. In addition, since the processing for image display and the processing for touch detection need to be performed in a time-division manner, it is difficult to ensure a sufficiently long touch detection period in a high-definition liquid crystal display device. Moreover, although the processing capacity per unit time can be increased by increasing the number of AFEs, increasing the number of AFEs leads to an increase in size of the IC and an increase in cost.

By the way, when one stylus pen is in use, a plurality of positions are not touched at the same time. Therefore, it is considered sufficient to be able to specify one touched position when one stylus pen is used. Thus, in consideration of this respect, the liquid crystal display device according to the present embodiment employs a drive method described below so that a touched position at one place can be specified in a short time when the detection target is the stylus pen.

<3.1 Coupling (Grouping) of a Plurality of Sensor Electrodes>

In the present embodiment, when the detection target is the stylus pen, the sensor shape is changed in a pseudo manner by electrically connecting a plurality of sensor electrodes 12 to each other. This will be described below. Here, for convenience of description, it is assumed that 18 sensor electrodes 12 of three rows×six columns are provided and the AFE block 20L made up of the three AFEs 201 to 203 corresponding to the first to third columns and the AFE block 20R made up of the three AFEs 204 to 206 corresponding to the fourth to sixth columns are provided.

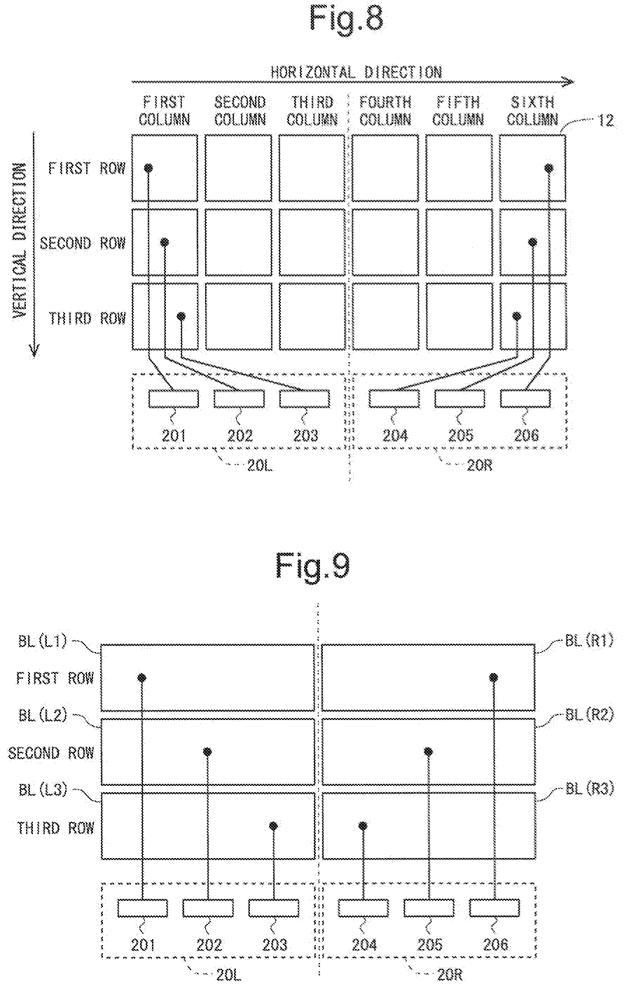

FIG. 8 is a diagram showing a state of the sensor electrodes 12 when the detection target is a finger. As shown in FIG. 8, when the detection target is a finger, the 18 sensor electrodes 12 are maintained in an electrically separated state. In such a state, the touch detection is performed for the first column and the sixth column in a certain predetermined period (first touch detection period), the touch detection is performed for the second column and the fifth column in the next predetermined period (second touch detection period), and the touch detection is performed for the third column and the fourth column in the next predetermined period (third touch detection period). In the first touch detection period, the AFEs 201 to 203 are respectively connected to the three sensor electrodes 12 in the first column, and the AFEs 204 to 206 are respectively connected to the three sensor electrodes 12 in the sixth column (a state shown in FIG. 8) . In the second touch detection period, the AFEs 201 to 203 are respectively connected to the three sensor electrodes 12 in the second column, and the AFEs 204 to 206 are respectively connected to the three sensor electrodes 12 in the fifth column. In the third touch detection period, the AFEs 201 to 203 are respectively connected to the three sensor electrodes 12 in the third column, and the AFEs 204 to 206 are respectively connected to the three sensor electrodes 12 in the fourth column.

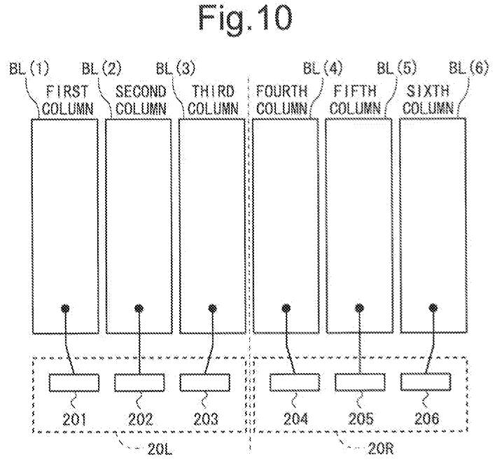

FIG. 9 and FIG. 10 are diagrams showing the state of the sensor electrodes 12 when the detection target is a stylus pen. As can be understood from FIG. 9 and FIG. 10, when the detection target is a stylus pen, a plurality of sensor electrodes 12 are electrically connected to each other to form an electrode block in a pseudo manner. It should be noted that, in the present specification, the electrical connection of the plurality of sensor electrodes 12 so as to form a pseudo electrode block is referred to as “grouping” for convenience.

In the present embodiment, when the detection target is a stylus pen, two predetermined periods (hereinafter referred to as a “first scan period” and a “second scan period” for convenience) are provided as periods for performing the touch detection on the entire display unit. It is assumed here that a state of the sensor electrodes 12 becomes a state shown in FIG. 9 during the first scan period, and a state of the sensor electrodes 12 becomes a state shown in FIG. 10 during the second scan period. Note that the first detection processing period is realized by the first scan period, and the second detection processing period is realized by the second scan period.

In the first scan period, a plurality of sensor electrodes 12 (three sensor electrodes 12) are electrically connected to each other for each row in each of the left half region in the touch panel 115 and the right half region in the touch panel 115 (see FIG. 9). Thereby, in the left half region in the touch panel 115, for example, an electrode block BL(L3) is formed by the three sensor electrodes 12 arranged in the third row. Further, in the right half region in the touch panel 115, for example, an electrode block BL(R1) is formed by the three sensor electrodes 12 arranged in the first row. As shown in FIG. 9, the AFE 201 is connected to an electrode block BL(L1), the AFE 202 is connected to an electrode block BL(L2), the AFE 203 is connected to the electrode block BL(L3), the AFE 204 is connected to the electrode block BL(R1), the AFE 205 is connected to an electrode block BL(R2), and the AFE 206 is connected to an electrode block BL(R3). That is, each of all electrode blocks is connected to any AFE. Therefore, in regard to each of the six electrode blocks, whether there is a touch can be determined during the first scan period.

Although it is assumed here that 18 sensor electrodes 12 of three rows×six columns are provided, in a case in which K (K is an integer of 4 or more) sensor electrodes 12 are provided, each P (P is an integer of 2 or more and K/2 or less) sensor electrodes 12 arranged in the horizontal direction (first direction) in FIG. 8 may be electrically connected so that each group is configured of P sensor electrodes 12. In the present embodiment, the first grouping processing is realized by the processing for grouping in the horizontal direction in FIG. 8 in this manner.

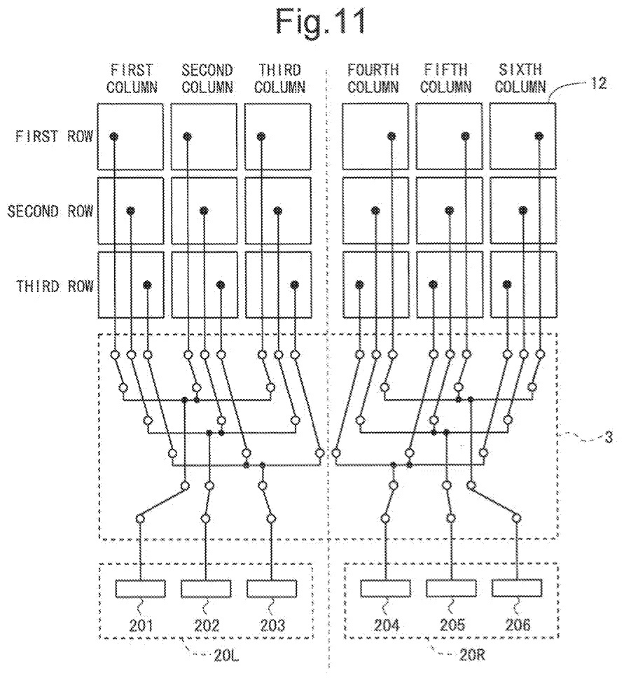

Meanwhile, in the present embodiment, in order to achieve the states shown in FIGS. 8 to 10, a switch group 3 made up of a plurality of switches is provided in a region between the sensor electrodes 12 and the AFEs. In the first scan period described above, each switch included in the switch group 3 is controlled so that a connection state as shown in FIG. 11 is obtained. For example, when focusing on the AFE 202 in FIG. 11, the AFE 202 is connected by a switch to the three sensor electrodes 12 in the second row in the left half region in the touch panel 115. Further, for example, when focusing on the AFE 206 in FIG. 11, the AFE 206 is connected by a switch to the three sensor electrodes 12 in the first row in the right half region in the touch panel 115. In this manner, the state shown in FIG. 9 is achieved.

In the second scan period, a plurality of sensor electrodes 12 (three sensor electrodes 12) are electrically connected to each other for each column in each of the left half region in the touch panel 115 and the right half region in the touch panel 115 (see FIG. 10). Thereby, in the left half region in the touch panel 115, for example, an electrode block BL(2) is formed by the three sensor electrodes 12 arranged in the second column. Further, in the right half region in the touch panel 115, for example, an electrode block BL(6) is formed by the three sensor electrodes 12 arranged in the sixth column. As shown in FIG. 10, the AFE 201 is connected to an electrode block BL(1), the AFE 202 is connected to the electrode block BL(2), the AFE 203 is connected to an electrode block BL(3), the AFE 204 is connected to an electrode block BL(4), the AFE 205 is connected to an electrode block BL(5), and the AFE 206 is connected to the electrode block BL(6). That is, each of all electrode blocks is connected to any AFE. Therefore, in regard to each of the above six electrode blocks, whether there is a touch can be determined during the second scan period.

Although it is assumed here that 18 sensor electrodes 12 of three rows×six columns are provided, in a case in which K (K is an integer of 4 or more) sensor electrodes 12 are provided, each Q (Q is an integer of 2 or more and K/2 or less) sensor electrodes 12 arranged in the vertical direction (second direction) in FIG. 8 may be electrically connected so that each group is made up of Q sensor electrodes 12. In the present embodiment, the second grouping processing is realized by the processing for grouping in the vertical direction in FIG. 8 in this manner.

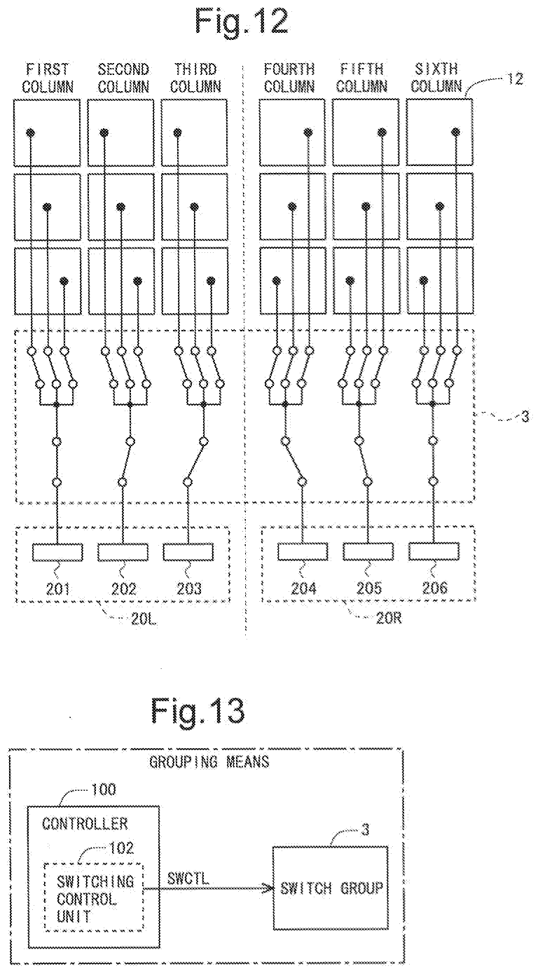

In the second scan period described above, each switch included in the switch group 3 is controlled so that a connection state as shown in FIG. 12 is obtained. For example, when focusing on the AFE 201 in FIG. 12, the AFE 201 is connected by a switch to the three sensor electrodes 12 in the first column. Further, for example, when focusing on the AFE 205 in FIG. 12, the AFE 205 is connected by a switch to the three sensor electrodes 12 in the fifth column. In this manner, the state shown in FIG. 10 is achieved.

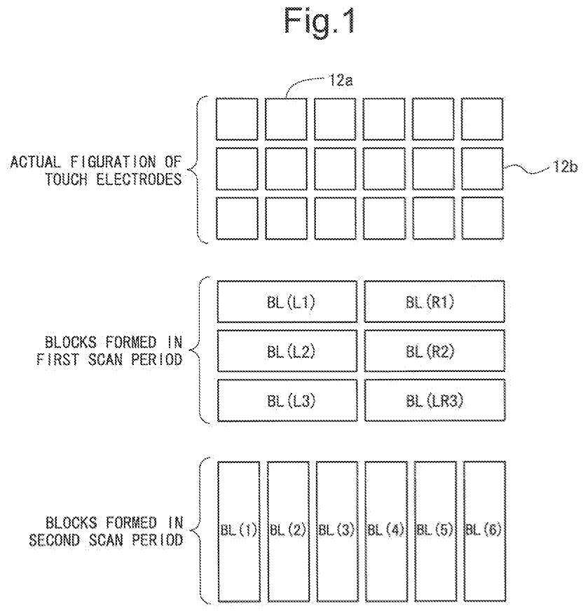

As a result of determining whether there is a touch for each electrode block in the first scan period and the second scan period as described above, for example, when a determination is made that there is a touch to the electrode block BL(L1) in the first scan period and a determination is made that there is a touch to the electrode block BL(2) in the second scan period, it is determined that there is a touch to the sensor electrode indicated by reference numeral 12a in FIG. 1. In addition, for example, when a determination is made that there is a touch to the electrode block BL(R2) in the first scan period and a determination is made that there is a touch to the electrode block BL(6) in the second scan period, it is determined that there is a touch to the sensor electrode indicated by reference numeral 12b in FIG. 1. In this manner, the touched position is specified with the original resolution using the two scan periods.

It should be noted that, in order to realize the grouping operation as described above, a switching control unit 102 that controls the operation of the switch group 3 is provided in the controller 100 as shown in FIG. 13. In the present embodiment, a grouping unit is realized by the switching control unit 102 and the switch group 3. Further, a switching circuit unit is realized by the switch group 3.

<3.2 Specific Configuration Example of Switch Group>

Here, a specific configuration example of the switch group 3 will be described. However, the configuration of the switch group 3 is not particularly limited so long as the connection state shown in each of FIG. 11 and FIG. 12 can be achieved.

<3.2.1 First Example>

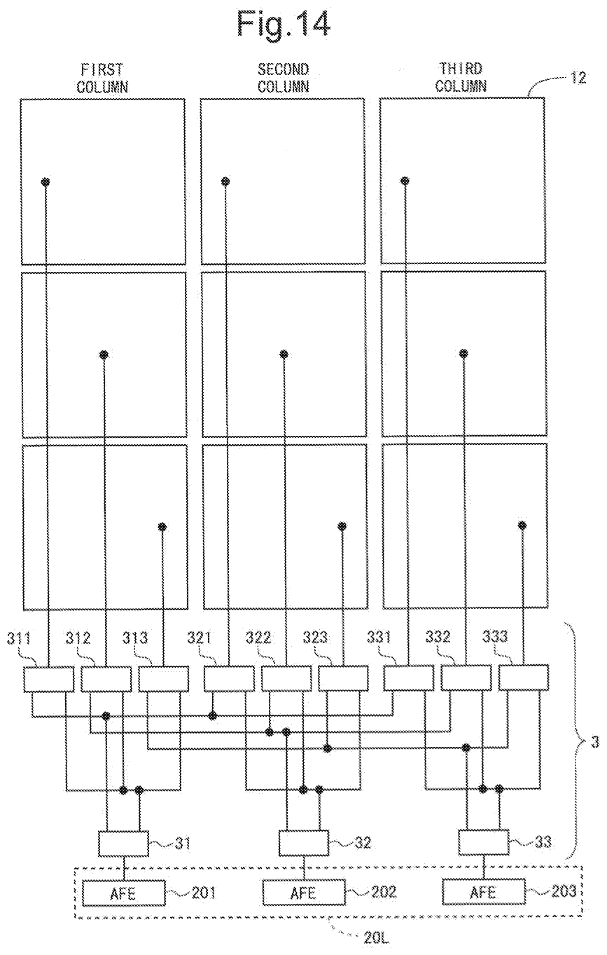

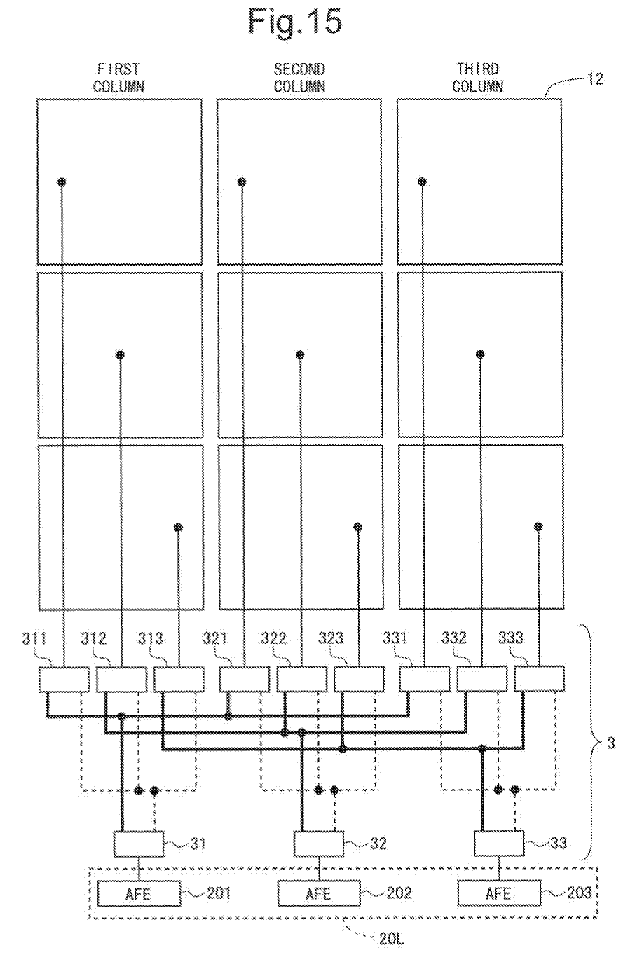

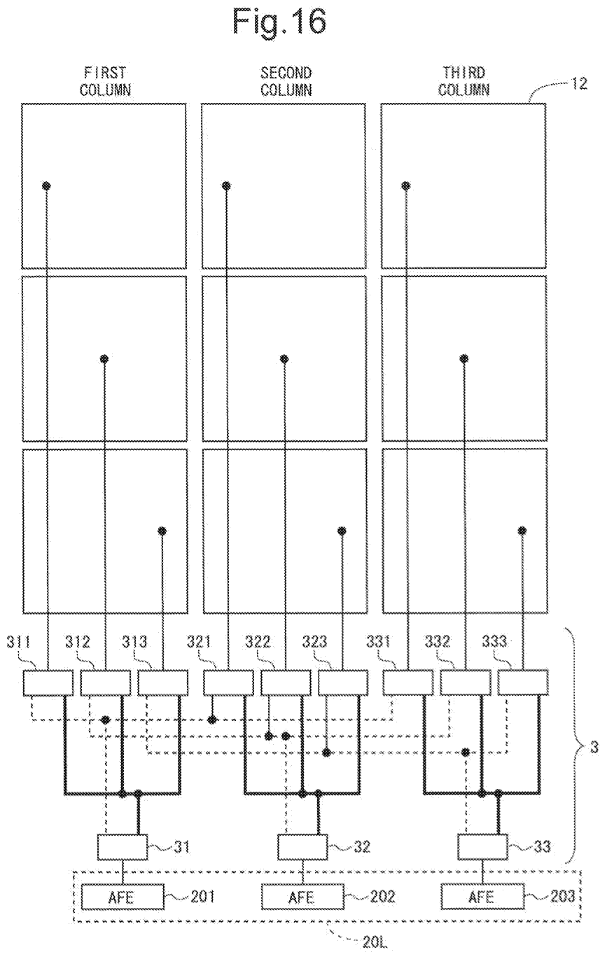

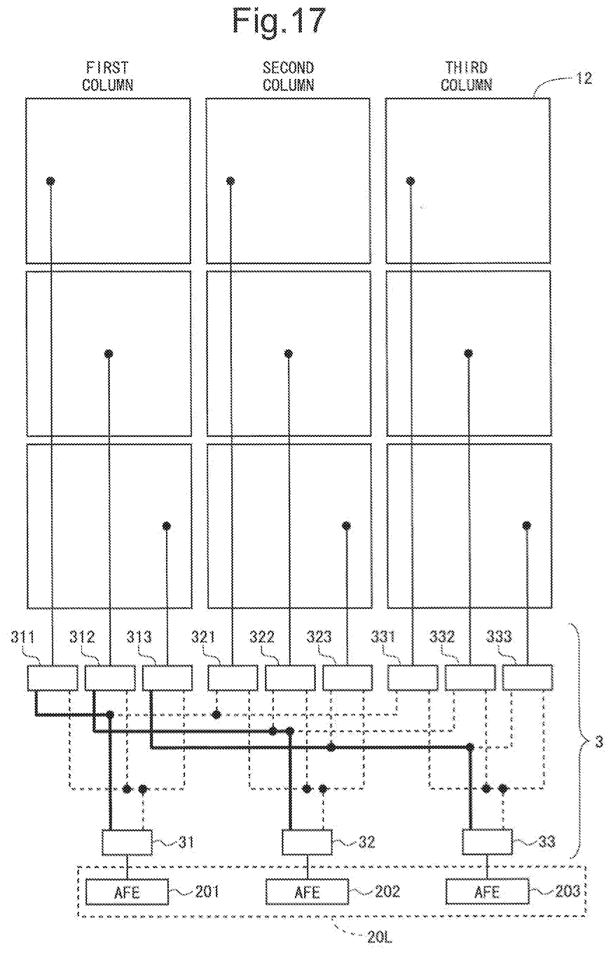

FIG. 14 is a diagram showing a first example of a specific configuration of the switch group 3. Here, only the components corresponding to the AFE block 20L (see FIG. 8) are focused. In the first example, the switch group 3 is made up of nine selectors 311 to 313, 321 to 323, and 331 to 333 each having an input end connected to a sensor electrode 12, and three selectors 31 to 33 each having an output end connected to an AFE. The connection destination of each of these selectors is controlled by a control signal given from the above-described switching control unit 102 (see FIG. 13). The connection destinations on the output end sides of the selectors 311 to 313, 321 to 323, and 331 to 333 and the connection destinations on the input end sides of the selectors 31 to 33 are switched between the first scan period and the second scan period. Specifically, in the first scan period, the connection destination of each selector is controlled so that the connection relationship as shown by a thick solid line in FIG. 15 is obtained for the region where the switch group 3 is provided. Further, in the second scan period, the connection destination of each selector is controlled so that the connection relationship shown by a thick solid line in FIG. 16 is obtained for the region where the switch group 3 is provided. It should be noted that, when the detection target is a finger, for example, if the processing target is the first column, the connection destination of each selector is controlled so that the connection relationship shown by a thick solid line in FIG. 17 is obtained for the region where the switch group 3 is provided.

In the first example, first type selectors are realized by the selectors 311 to 313, 321 to 323, and 331 to 333, second type selectors are realized by the selectors 31 to 33.

<3.2.2 Second Example>

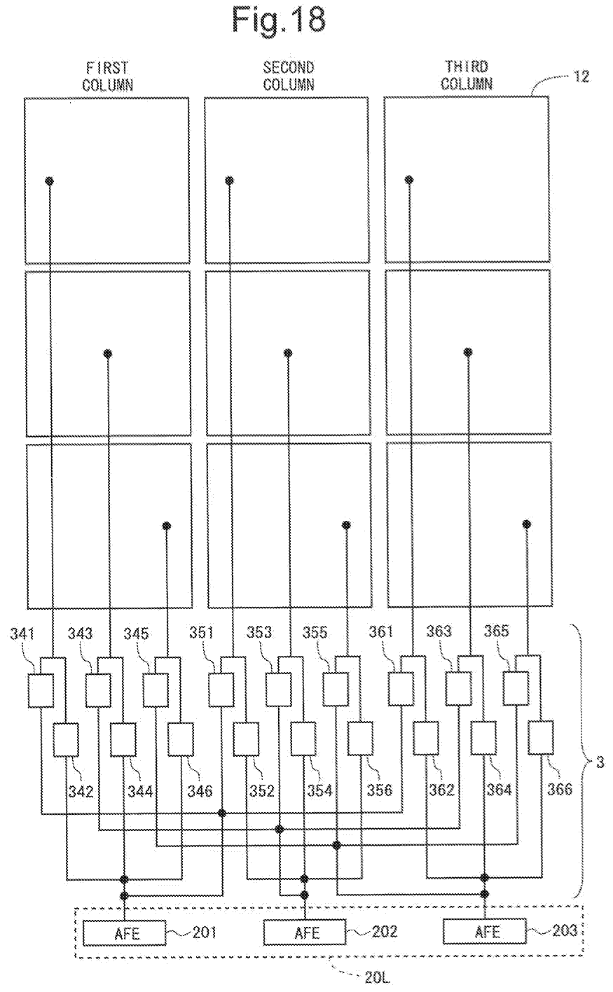

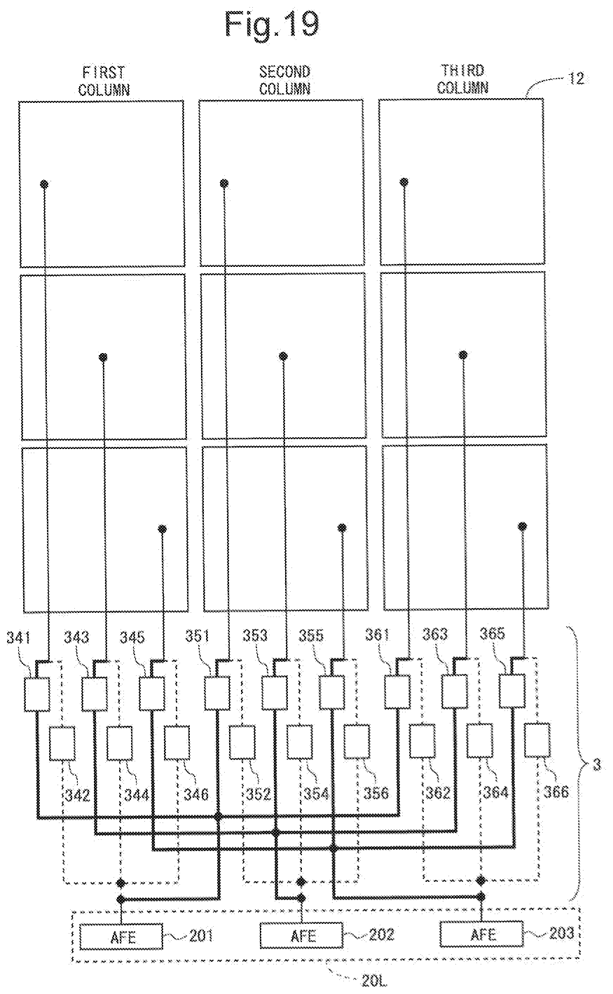

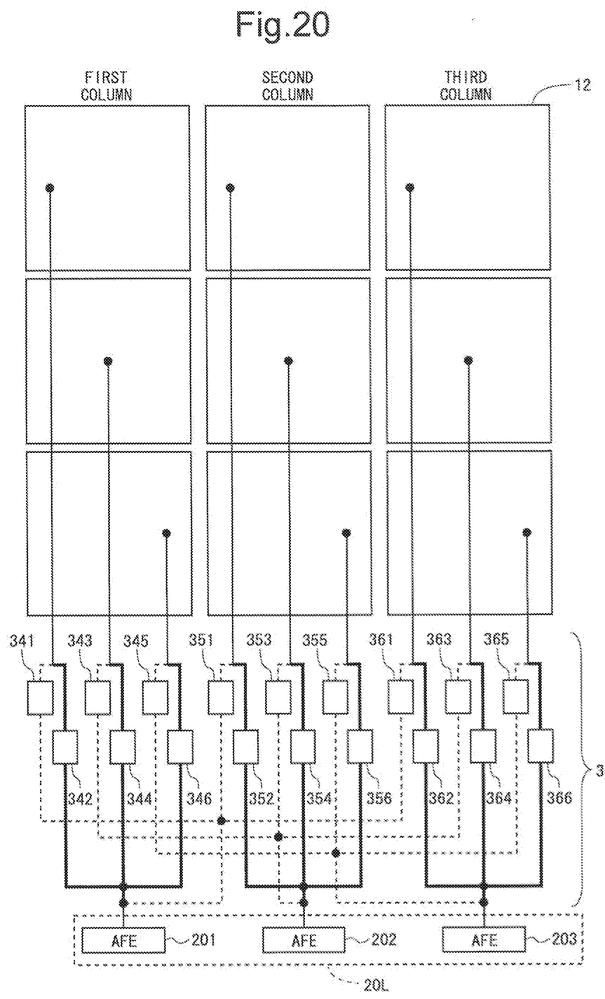

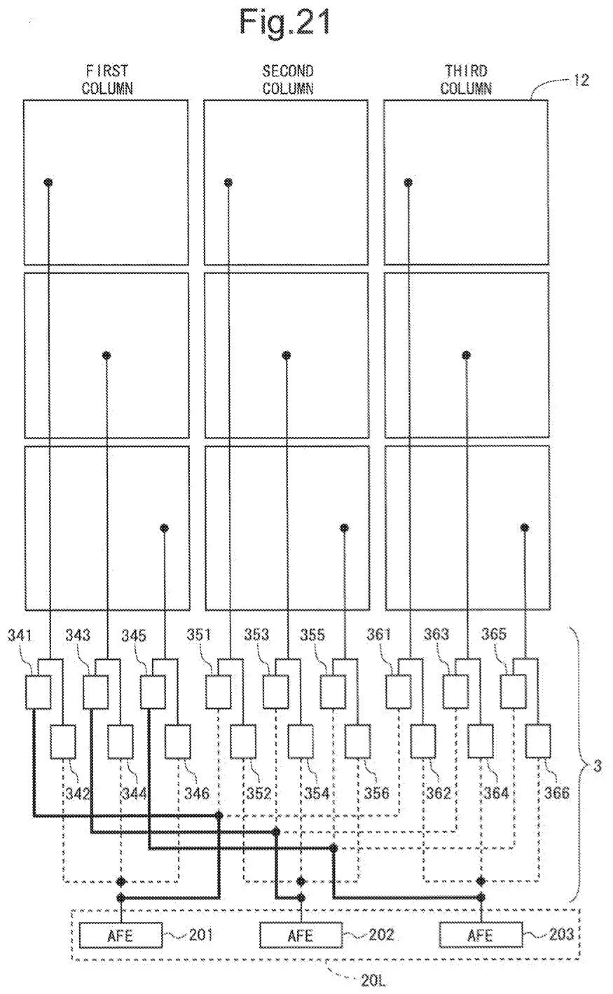

FIG. 18 is a diagram showing a second example of a specific configuration of the switch group 3. It should be noted that only the components corresponding to the AFE block 20L are focused here as well. In the second example, the switch group 3 is made up of a total of 18 transistors 341 to 346, 351 to 356, and 361 to 366, where two transistors are provided for each sensor electrode 12 (i.e., six transistors are provided for each column). Each of these transistors has a control terminal to which a control signal is given, a first conduction terminal connected to a sensor electrode 12, and a second conduction terminal connected to an analog front end, and the on/off-state of each of these transistors is controlled by a control signal given from the above-described switching control unit 102 (see FIG. 13). In the first scan period, transistors given odd-numbered reference numerals are in the on-state, and transistors given even-numbered reference numerals are in the off-state. Thereby, the connection relationship as shown by a thick solid line in FIG. 19 is obtained for the region where the switch group 3 is provided. In the second scan period, the transistors given odd-numbered reference numerals are in the off-state and the transistors given even-numbered reference numerals are in the on-state. As a result, a connection relationship as shown by a thick solid line in FIG. 20 is obtained for the region where the switch group 3 is provided. In this manner, concerning the two transistors corresponding to each sensor electrode 12, the second conduction terminal of one transistor is connected to one of the plurality of analog front ends so as to enable the grouping in the horizontal direction in FIG. 8 (first grouping processing), and the second conduction terminal of the other transistor is connected to one of the plurality of analog front ends so as to enable the grouping in the vertical direction in FIG. 8 (second grouping processing). It should be noted that, when the detection target is a finger, for example, if the processing target is the first column, the on/off-state of each transistor is controlled so that the connection relationship shown by a thick solid line in FIG. 21 is obtained for the region where the switch group 3 is provided.

<3.3 Time-Division Drive Method>

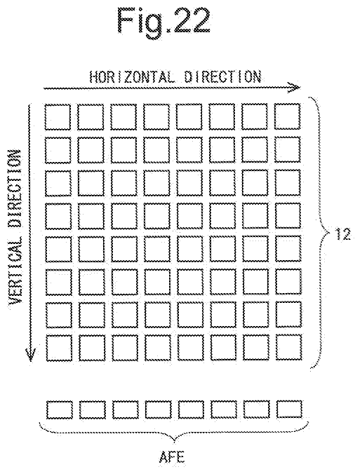

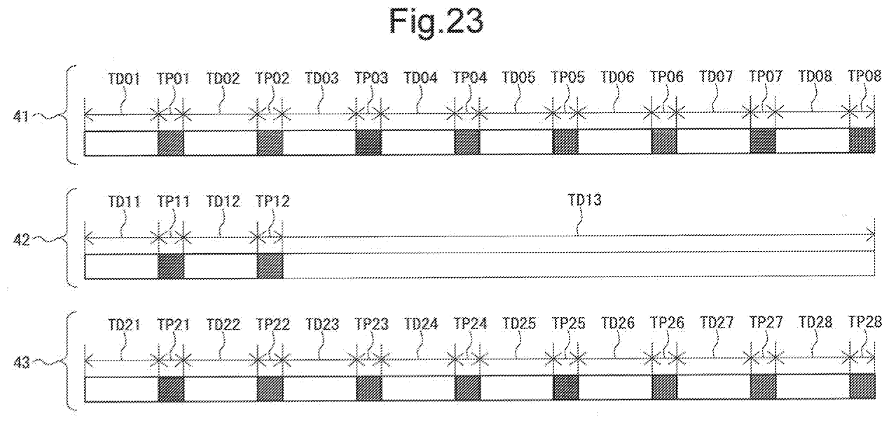

Next, a description will be given of a time-division drive method in which the processing for image display and the processing for touch detection are performed in a time-division manner. Here, for convenience of description, it is assumed that 64 sensor electrodes 12 of eight rows×eight columns and eight AFEs are provided as shown in FIG. 22. FIG. 23 is a diagram for explaining the time-division drive method in the present embodiment. In FIG. 23, a period indicated by an arrow with a symbol starting with “TD” represents a display period in which the processing for image display is performed, and a period indicated by an arrow with a symbol starting with “TP” represents a touch detection period in which the processing for touch detection is performed.

When the detection target is a finger, the display period and the touch detection period are alternately repeated as shown in the portion denoted by reference numeral 41 in FIG. 23. In one touch detection period, the touch detection for one column is performed. For example, in a touch detection period TP01, eight AFEs are respectively connected to the eight sensor electrodes 12 in the first row, and in the touch detection period TP02, the eight AFEs are respectively connected to the eight sensor electrodes 12 in the second column. In this manner, one touch detection on the entire display unit is completed by eight touch detection periods TP01 to TP08.

As for the case where the detection target is a stylus pen, two drive examples (first drive example and second drive example) will be described.

In the first drive example, as shown in the portion denoted by reference numeral 42 in FIG. 23, after each of the display period and the touch detection period is provided twice, a relatively long display period is provided. A touch detection period TP11 corresponds to the above-described first scan period, and a touch detection period TP12 corresponds to the above-described second scan period. In the touch detection period TP11, eight sensor electrodes 12 are electrically connected to each other for each row, and eight electrode blocks each extending in the horizontal direction are formed. Then, the eight AFEs are respectively connected to the eight electrode blocks, and whether there is a touch is determined for each of the eight electrode blocks. In the touch detection period TP12, eight sensor electrodes 12 are electrically connected to each other for each column, and eight electrode blocks each extending in the vertical direction are formed. Then, the eight AFEs are respectively connected to the eight electrode blocks, and whether there is a touch is determined for each of the eight electrode blocks. Thereby, the position touched with the stylus pen is detected with the original resolution.

As above, in the first drive example, when a period that is as long as a time required for one touch detection to the entirety of the display unit in a case in which the detection target is a finger is defined as a unit period, the unit period in a case in which the detection target is a stylus pen is made up of one first scan period TP11 during which the touch detection is performed in a state where the grouping in the horizontal direction in FIG. 8 (first grouping processing) is performed, one second scan period TP12 during which the touch detection is performed in a state where the grouping in the vertical direction in FIG. 8 (second grouping processing) is performed, and one or more display periods TD11, TD12, and TD13 during which the image display on the display unit 150 is performed. The one or more display periods TD11, TD12, and TD13 include the display period TD13 that is longer than each of the display periods TD01 to TD08 in a case in which the detection target is a finger.

According to the first drive example described above, by completing the touch detection on the entire display unit in two touch detection periods, the relatively long display period TDl3 is provided after the touch detection period TP12. In this manner, a long period can be allocated for the processing for image display. Therefore, even when a high-resolution liquid crystal panel is in use, it is possible to reliably write to the pixel capacitance. In addition, since the size of the pixel TFT can be reduced, the luminance can be enhanced.

In the second drive example, as shown in a portion denoted by reference numeral 43 in FIG. 23, the display period and the touch detection period are repeated in the same manner as when the detection target is a finger. Here, each of touch detection periods TP21, TP23, TP25, and TP27 corresponds to the above-described first scan period, and touch detection periods TP22, TP24, TP26, and TP28 corresponds to the above-described second scan period. That is, according to the second drive example, the touch detection on the entire display unit is repeated four times during a period in which one touch detection is performed on the entire display unit in a case in which the detection target is a finger.

As above, in the second drive example, when a period that is as long as a time required for one touch detection to the entirety of the display unit in a case in which the detection target is a finger is defined as a unit period, the unit period in a case in which the detection target is a stylus pen is made up of a plurality of first scan periods TP21, TP23, TP25, and TP27 during which the touch detection is performed in a state where the grouping in the horizontal direction in FIG. 8 (first grouping processing) is performed, a plurality of second scan periods TP22, TP24, TP26, and TP28 during which the touch detection is performed in a state where the grouping in the vertical direction in FIG. 8 (second grouping processing) is performed, and a plurality of display periods TD21 to TD28 during which the image display on the display unit 150 is performed. When only the first scan period and the second scan period are focused in the unit period, the first scan period and the second scan period appear alternately.

According to the second drive example described above, the number of sampling times for touch detection can be increased. Therefore, effects such as improved resistance to noise, faster response, and increase in performance of smoothing processing can be obtained.

It should be noted that, depending on the purpose of use of the user, the simultaneous use of a finger and a stylus pen may be desired. Regarding this, the drive control unit 111 (see FIG. 2) may perform the switching of the drive system so that drive with a finger as the detection target (drive indicated by reference numeral 41 in FIG. 23) (first touch detection drive) and drive with a stylus pen as the detection target (drive indicated by reference numeral 42 or 43 in FIG. 23) (second touch detection drive) are performed in a time-division manner. However, since the touch detection for a finger and the touch detection for a stylus pen are performed, the sampling speed decreases.

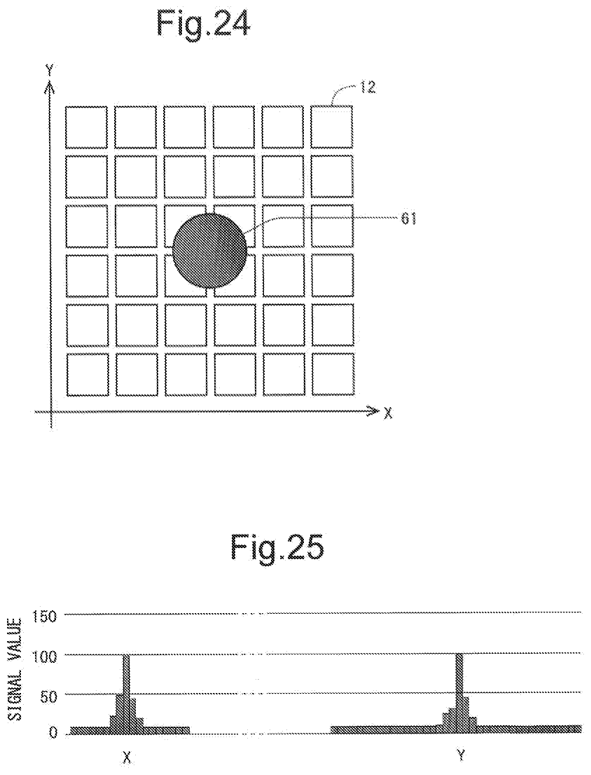

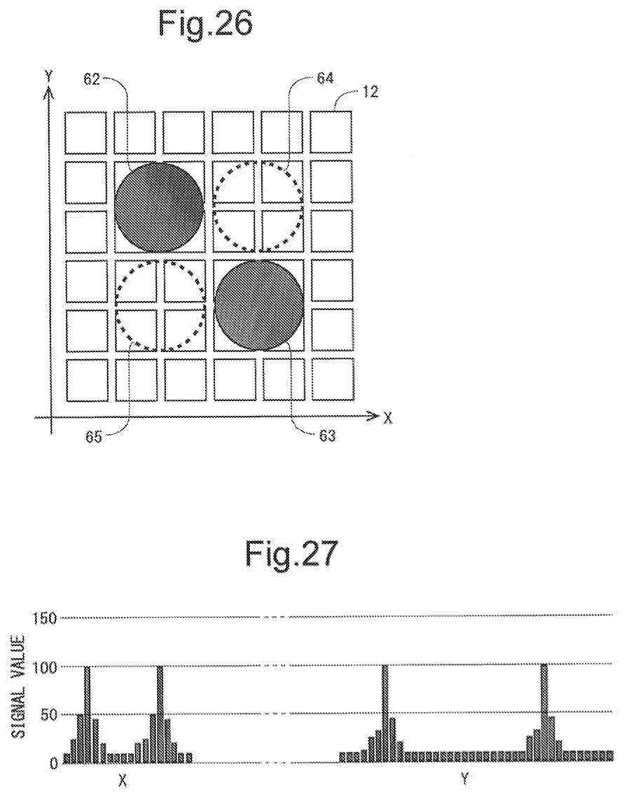

By the way, if a position indicated by reference numeral 61 in FIG. 24 is touched when the detection target is a stylus pen, signal value data as shown in FIG. 25 is obtained in each of the X direction and the Y direction. With this, a touched position can be specified. However, if a position indicated by reference numeral 62 and a position indicated by reference numeral 63 in FIG. 26 are touched simultaneously, signal value data as shown in FIG. 27 is obtained in each of the X direction and the Y direction. In this case, a so-called ghost phenomenon occurs, and it is not possible to determine whether the combination of the touched positions is “a combination of the position indicated by reference numeral 62 and the position indicated by reference numeral 63” or “a combination of a position indicated by reference numeral 64 and a position indicated by reference numeral 65.” Therefore, in a case in which two stylus pens are used, an ID is assigned to each of the two stylus pens, and drive for the first stylus pen and drive for the second stylus pen are performed in a time-division manner, whereby simultaneous touch at two places can be detected. By employing such a drive method, it is possible to detect simultaneous touch at two places in a shorter time than in the past. It should be noted that, even when three or more stylus pens are used, it is possible to detect simultaneous touch at a plurality of places in the same manner. That is, in the configuration in which an ID assignment means for assigning an ID to each of a plurality of stylus pens is provided in, for example, the touch panel control unit 110, the touch detection with a stylus pen as the detection target may be performed for each ID in a time-division manner.

<4. Effects>

According to the present embodiment, when the detection target is a stylus pen, the touch detection in a state where each a plurality of sensor electrodes 12 arranged side by side in the horizontal direction are connected electrically and the touch detection in a state where each a plurality of sensor electrodes 12 arranged side by side in the vertical direction are connected electrically are performed. Since the touch detection is performed in a state where a plurality of sensor electrodes 12 are grouped in this manner, detection signals can be sufficiently processed by a relatively small number of AFEs. In addition, when one stylus pen is in use, it is sufficient to be able to specify one touched position, and hence the touched position can be accurately specified by two touch detections in the above-described state. As above, according to the present embodiment, a display device with a built-in touch sensor that has a small-scale circuit and is capable of performing accurate touch detection even when the stylus pen is in use is realized.

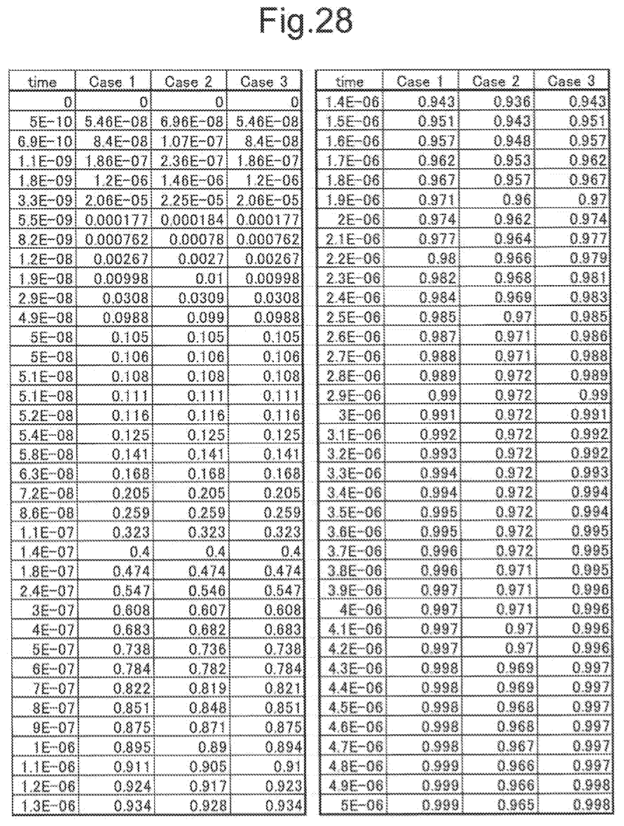

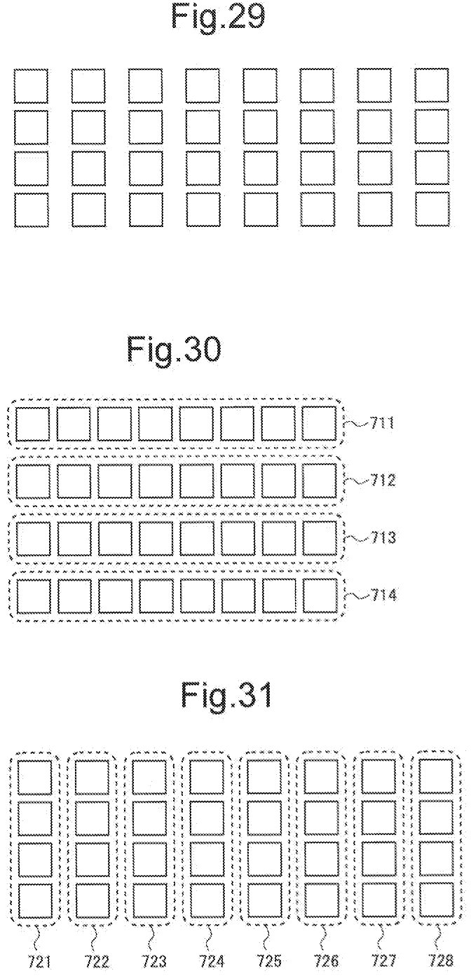

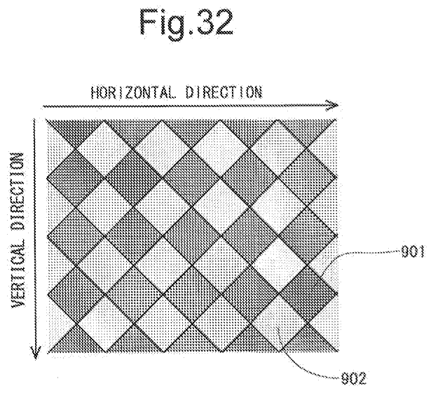

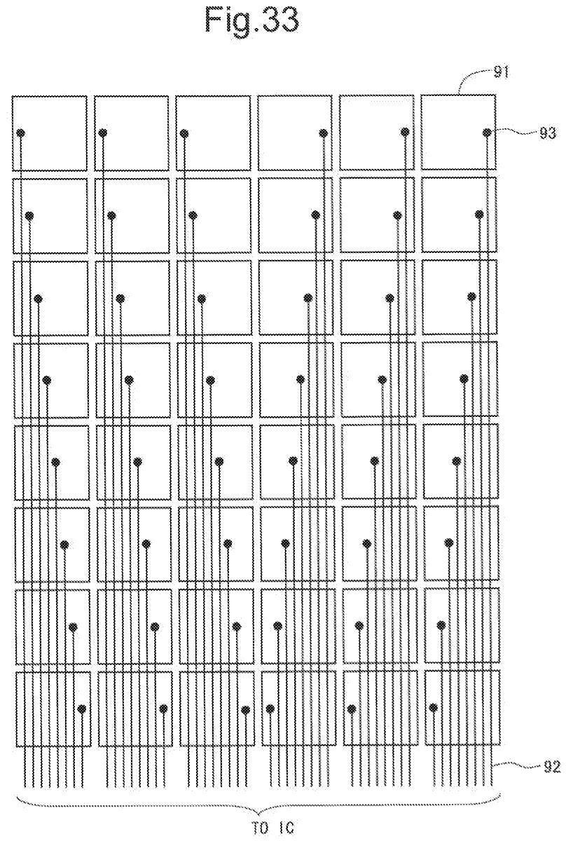

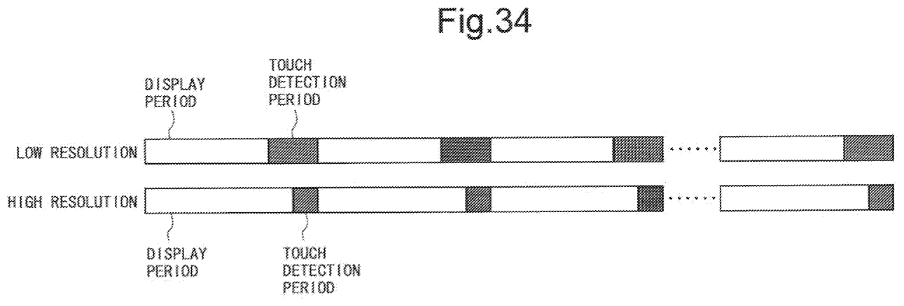

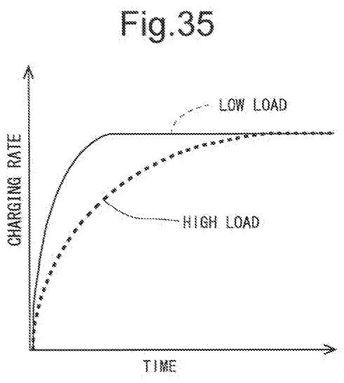

Here, a description will be given of an influence on charging characteristics (charging characteristics of the touch detecting capacitance) by changing the sensor shape in a pseudo manner. FIG. 28 is a table showing a change in charging rate with time by case for certain simulation. “Case 1” represents a case where all the sensor electrodes 12 are not connected to other sensor electrodes 12 as shown in FIG. 29. “Case2” represents a case where a plurality of sensor electrodes 12 are electrically connected to each other one row by one row as indicated by reference numerals 711 to 714 in FIG. 30. “Case 3” represents a case where a plurality of sensor electrodes 12 are electrically connected to each other one column by one column as indicated by reference numerals 721 to 728 in FIG. 31. It is understood from FIG. 28 that the charging rate changes in almost the same manner in all the cases. That is, even when the sensor shape is changed in a pseudo manner as described above, the charging characteristics of the touch detecting capacitance hardly change. Therefore, when the touch is performed with a stylus pen, the touched position can be specified with high accuracy using the first scan period and the second scan period described above.

Further, even if the number of sensor electrodes 12 to be connected is increased, the charging characteristics hardly change. Accordingly, even when the number of sensor electrodes included in one electrode block is increased as in a medium-sized or large-sized liquid crystal display device, it is possible to accurately specify a position touched with a stylus pen. In this regard, the effect of reducing the sampling time increases with increase in the number of sensor electrodes included in one electrode block.

<5. Others>

The present invention is not limited to each of the above embodiments, and can be implemented by making various modifications thereto without departing from the gist of the present invention. For example, in the embodiment described above, the description has been given by the example in which a stylus pen is used as the operation means except for a finger. However, the present invention can also be applied to a case where an operation means except for the stylus pen is used.

<6. Additional Notes>

As the configurations of a display device with a built-in touch sensor that has a small-scale circuit and is capable of performing accurate touch detection even when an operation means except for a finger (e.g., stylus pen) is in use and a drive method for the same, the following configurations are considered.

(Additional Note 1)

A display device with a built-in touch sensor, the display device having a display unit provided with K (K is an integer of 4 or more) sensor electrodes for touch detection arranged in a matrix, the display device including:

a plurality of analog front ends for processing detection signals obtained from the K sensor electrodes;

a grouping unit configured to perform

first grouping processing for electrically connecting each P (P is an integer of 2 or more and K/2 or less) sensor electrodes arranged side by side in a first direction so that each group is made up of the P sensor electrodes, and

second grouping processing for electrically connecting each Q (Q is an integer of 2 or more and K/2 or less) sensor electrodes arranged side by side in a second direction orthogonal to the first direction so that each group is made up of the Q sensor electrodes; and

a position detection processing unit configured to determine whether the K sensor electrodes are touched and specify a touched position, based on outputs from the plurality of analog front ends, wherein

in the first grouping processing and the second grouping processing, the grouping unit connects sensor electrodes constituting each group to an analog front end that is different from analog front ends to which sensor electrodes constituting another group are connected.

(Additional Note 2)

The display device according to additional note 1, wherein the grouping unit does not perform the first grouping processing and the second grouping processing when a detection target is a finger, and performs the first grouping processing and the second grouping processing when the detection target is a stylus pen.

(Additional Note 3)

The display device according to additional note 2, wherein

when a period that is as long as a time required for one touch detection to an entirety of the display unit in a case in which the detection target is a finger is defined as a unit period, the unit period in a case in which the detection target is a stylus pen is made up of one first detection processing period during which touch detection is performed in a state where the first grouping processing is performed by the grouping unit, one second detection processing period during which touch detection is performed in a state where the second grouping processing is performed by the grouping unit, and one or more display periods during which image display on the display unit is performed, and

the one or more display period includes a display period that is longer than a display period when the detection target is a finger.

(Additional Note 4)

The display device according to additional note 2, wherein

when a period that is as long as a time required for one touch detection to an entirety of the display unit in a case in which the detection target is a finger is defined as a unit period, the unit period in a case in which the detection target is a stylus pen is made up of a plurality of first detection processing periods during which touch detection is performed in a state where the first grouping processing is performed by the grouping unit, a plurality of second detection processing periods during which touch detection is performed in a state where the second grouping processing is performed by the grouping unit, and a plurality of display periods during which image display on the display unit is performed, and

when focusing only on the first detection processing period and the second detection processing period in the unit period, the first detection processing period and the second detection processing period appear alternately.

(Additional Note 5)

The display device according to additional note 2, further comprising a drive control unit configured to control switching of a drive system between first touch detection drive with a finger as the detection target and second touch detection drive with a stylus pen as the detection target, wherein

the drive control unit performs the switching of the drive system so that the first touch detection drive and the second touch detection drive are performed in a time-division manner.

(Additional Note 6)

The display device according to additional note 2, further comprising an ID assignment unit configured to assign an ID to each of a plurality of stylus pens, wherein

when a plurality of stylus pens are in use, touch detection with a stylus pen as the detection target is performed for each ID in a time-division manner.

(Additional Note 7)

The display device according to additional note 1, wherein the grouping unit includes

a switching circuit unit for switching connection relationship between the K sensor electrodes and the plurality of analog front ends, and

a switching control unit configured to control operation of the switching circuit unit.

(Additional Note 8)

The display device according to additional note 7, wherein

the switching circuit unit is made up of a plurality of first type selectors each having two output ends and one input end connected to a sensor electrode, and a plurality of second type selectors each having two input ends and one output end connected to an analog front end,

one of the output ends of the plurality of first type selectors and one of the input ends of the plurality of second type selectors are connected so as to enable the first grouping processing, and the other of the output ends of the plurality of first type selectors and the other of the input ends of the plurality of second type selectors are connected so as to enable the second grouping processing.

(Additional Note 9)

The display device according to additional note 7, wherein

the switching circuit unit is made up of a plurality of transistors each having a control terminal to which a signal for controlling an on/off-state is given, a first conduction terminal connected to a sensor electrode, and a second conduction terminal connected to an analog front end, such that two transistors correspond to one sensor electrode, and

concerning two transistors corresponding to each sensor electrode, the second conduction terminal of one of the transistors is connected to one of the plurality of analog front ends so as to enable the first grouping processing, and the second conduction terminal of the other of the transistors is connected to one of the plurality of analog front ends so as to enable the second grouping processing.

(Additional Note 10)

The display device according to additional note 1, wherein

the display unit includes a pixel electrode for being applied with a voltage in accordance with a display image, and a common electrode provided facing the pixel electrode, and

the K sensor electrodes are shared with the common electrode.

(Additional Note 11)

A drive method for a display device with a built-in touch sensor, the display device having a display unit provided with K (K is an integer of 4 or more) sensor electrodes for touch detection arranged in a matrix, and a plurality of analog front ends for processing detection signals obtained from the K sensor electrodes, the method including:

a first grouping step of electrically connecting each P (P is an integer of 2 or more and K/2 or less) sensor electrodes arranged side by side in a first direction so that each group is made up of the P sensor electrodes;

a second grouping step of electrically connecting each Q (Q is an integer of 2 or more and K/2 or less) sensor electrodes arranged side by side in a second direction orthogonal to the first direction so that each group is made up of the Q sensor electrodes; and

a position detection step of determining whether the K sensor electrodes are touched and specifying a touched position, based on outputs from the plurality of analog front ends, wherein

in the first grouping step and the second grouping step, sensor electrodes constituting each group are connected to an analog front end that is different from analog front ends to which sensor electrodes constituting another group are connected.

According to such configurations described in additional notes 1 to 11, when an operation means except for the finger (e.g., stylus pen) is in use, it is possible to perform touch detection in a state where each a plurality of sensor electrodes arranged side by side in a first direction (e.g., a direction in which scanning signal lines extend) are connected electrically and touch detection in a state where each a plurality of sensor electrodes arranged side by side in a second direction (e.g., a direction in which video signal lines extend) are connected electrically. Since the touch detection can be performed in a state where a plurality of sensor electrodes are grouped in this manner, detection signals can be sufficiently processed by a relatively small number of analog front ends. In addition, when a pen or the like is in use on a tablet terminal, a product called “2 in 1”, a notebook computer, a mobile phone (especially a smartphone), and the like, it is sufficient to be able to specify one touched position, and hence the touched position can be accurately specified by two touch detections in the above-described state. As above, a display device with a built-in touch sensor that has a small-scale circuit and is capable of performing accurate touch detection even when an operation means except for a finger (e.g., stylus pen) is in use is realized.

<7. Regarding Priority Claim>

This application claims priority to Japanese Patent Application No. 2017-137635 titled “DISPLAY DEVICE WITH BUILT-IN TOUCH SENSOR, AND DRIVE METHOD FOR SAME” filed Jul. 14, 2017, the content of which is incorporated herein by reference.

### DESCRIPTION OF REFERENCE CHARACTERS

3: Switch group

10: TFT array substrate

11: IC

12: Sensor electrode

13: Touch detecting wire

14: Contact portion

20L, 20R: AFE block

54: Common electrode

100: Controller

102: Switching control unit

110: Touch panel control unit

111: Drive control unit

112: Touch panel drive unit

113: Position detection processing unit

115: Touch panel

120: Display control unit

201 to 206: AFE (analog front end)

SD: Drive signal

SX: Detection signal

1. A display device with a built-in touch sensor, the display device having a display unit provided with K (K is an integer of 4 or more) sensor electrodes for touch detection arranged in a matrix, the display device comprising:
a plurality of analog front ends for processing detection signals obtained from the K sensor electrodes;
a grouping unit configured to perform
first grouping processing for electrically connecting each P (P is an integer of 2 or more and K/2 or less) sensor electrodes arranged side by side in a first direction so that each group is made up of the P sensor electrodes, and
second grouping processing for electrically connecting each Q (Q is an integer of 2 or more and K/2 or less) sensor electrodes arranged side by side in a second direction orthogonal to the first direction so that each group is made up of the Q sensor electrodes; and
a position detection processing unit configured to determine whether the K sensor electrodes are touched and specify a touched position, based on outputs from the plurality of analog front ends, wherein
in the first grouping processing and the second grouping processing, the grouping unit connects sensor electrodes constituting each group to an analog front end that is different from analog front ends to which sensor electrodes constituting another group are connected.

2. The display device according to claim 1, wherein the grouping unit does not perform the first grouping processing and the second grouping processing when a detection target is a finger, and performs the first grouping processing and the second grouping processing when the detection target is a stylus pen.

3. The display device according to claim 2, wherein
when a period that is as long as a time required for one touch detection to an entirety of the display unit in a case in which the detection target is a finger is defined as a unit period, the unit period in a case in which the detection target is a stylus pen is made up of one first detection processing period during which touch detection is performed in a state where the first grouping processing is performed by the grouping unit, one second detection processing period during which touch detection is performed in a state where the second grouping processing is performed by the grouping unit, and one or more display periods during which image display on the display unit is performed, and
the one or more display period includes a display period that is longer than a display period when the detection target is a finger.

4. The display device according to claim 2, wherein
when a period that is as long as a time required for one touch detection to an entirety of the display unit in a case in which the detection target is a finger is defined as a unit period, the unit period in a case in which the detection target is a stylus pen is made up of a plurality of first detection processing periods during which touch detection is performed in a state where the first grouping processing is performed by the grouping unit, a plurality of second detection processing periods during which touch detection is performed in a state where the second grouping processing is performed by the grouping unit, and a plurality of display periods during which image display on the display unit is performed, and
when focusing only on the first detection processing period and the second detection processing period in the unit period, the first detection processing period and the second detection processing period appear alternately.

5. The display device according to claim 2, further comprising a drive control unit configured to control switching of a drive system between first touch detection drive with a finger as the detection target and second touch detection drive with a stylus pen as the detection target, wherein
the drive control unit performs the switching of the drive system so that the first touch detection drive and the second touch detection drive are performed in a time-division manner.

6. The display device according to claim 2, further comprising an ID assignment unit configured to assign an ID to each of a plurality of stylus pens, wherein
when a plurality of stylus pens are in use, touch detection with a stylus pen as the detection target is performed for each ID in a time-division manner.

7. The display device according to claim 1, wherein the grouping unit includes
a switching circuit unit for switching connection relationship between the K sensor electrodes and the plurality of analog front ends, and
a switching control unit configured to control operation of the switching circuit unit.

8. The display device according to claim 7, wherein
the switching circuit unit is made up of a plurality of first type selectors each having two output ends and one input end connected to a sensor electrode, and a plurality of second type selectors each having two input ends and one output end connected to an analog front end,
one of the output ends of the plurality of first type selectors and one of the input ends of the plurality of second type selectors are connected so as to enable the first grouping processing, and the other of the output ends of the plurality of first type selectors and the other of the input ends of the plurality of second type selectors are connected so as to enable the second grouping processing.

9. The display device according to claim 7, wherein
the switching circuit unit is made up of a plurality of transistors each having a control terminal to which a signal for controlling an on/off-state is given, a first conduction terminal connected to a sensor electrode, and a second conduction terminal connected to an analog front end, such that two transistors correspond to one sensor electrode, and
concerning two transistors corresponding to each sensor electrode, the second conduction terminal of one of the transistors is connected to one of the plurality of analog front ends so as to enable the first grouping processing, and the second conduction terminal of the other of the transistors is connected to one of the plurality of analog front ends so as to enable the second grouping processing.

10. The display device according to claim 1, wherein
the display unit includes a pixel electrode for being applied with a voltage in accordance with a display image, and a common electrode provided facing the pixel electrode, and
the K sensor electrodes are shared with the common electrode.

11. A drive method for a display device with a built-in touch sensor, the display device having a display unit provided with K (K is an integer of 4 or more) sensor electrodes for touch detection arranged in a matrix, and a plurality of analog front ends for processing detection signals obtained from the K sensor electrodes, the method comprising:
a first grouping step of electrically connecting each P (P is an integer of 2 or more and K/2 or less) sensor electrodes arranged side by side in a first direction so that each group is made up of the P sensor electrodes;
a second grouping step of electrically connecting each Q (Q is an integer of 2 or more and K/2 or less) sensor electrodes arranged side by side in a second direction orthogonal to the first direction so that each group is made up of the Q sensor electrodes; and
a position detection step of determining whether the K sensor electrodes are touched and specifying a touched position, based on outputs from the plurality of analog front ends, wherein
in the first grouping step and the second grouping step, sensor electrodes constituting each group are connected to an analog front end that is different from analog front ends to which sensor electrodes constituting another group are connected.
